(19) United States
(12) Patent Application Publication
(10) Pub. No.: US 2024/0340847 A1
(43) Pub. Date: Oct. 10, 2024

(54) FLOATING LOCALLY DISTRIBUTED USER PLANE FUNCTION

(71) Applicant: AT&T Intellectual Property I, L.P., Atlanta, GA (US)

(72) Inventors: Joseph Soryal, Glendale, NY (US); Christina Cacioppo, Freehold, NJ (US); Satyendra Tripathi, Marlboro, NJ (US)

(21) Appl. No.: 18/296,866

(22) Filed: Apr. 6, 2023

(51) Int. Cl. H04W 68/00

(52) U.S. Cl. CPC H04W 68/00; H04W 92/18

(57) ABSTRACT

A processing system including at least one processor deployed in a cellular network may detect at least one trigger condition for deploying a floating user plane function in an area. The processing system may deploy the floating user plane function in the area in response to the detecting of the at least one trigger condition, where the floating user plane function is hosted on at least one host mobile communication device that is in communication with the processing system. The processing system may then assign at least one protocol data unit session for at least a first user equipment to the floating user plane function.

The present disclosure relates generally to wireless communication networks (e.g., cellular communication networks), and more particularly to methods, non-transitory computer-readable media, and apparatuses for assigning at least one protocol data unit session for at least one user equipment to a floating user plane function; methods, non-transitory computer-readable media, and apparatuses for performing a data communication with a remote network via a floating user plane function for the at least one protocol data unit session for at least one user equipment; and methods, non-transitory computer-readable media, and apparatuses for performing a data communication with a remote network via a floating user plane function for at least one protocol data unit session for a first user equipment.

### BACKGROUND

A cloud radio access network (RAN) is part of the 3rd Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. For instance, in a 5G core network, a user plane function (UPF) may provide data plane functions which, in a 4G network, may be assigned to a packet gateway (PGW) providing both control and user plane functions.

### SUMMARY

In one example, the present disclosure discloses a device, computer-readable medium, and method for assigning at least one protocol data unit session for at least one user equipment to a floating user plane function. For instance, a processing system including at least one processor deployed in a cellular network may detect at least one trigger condition for deploying a floating user plane function in an area. The processing system may next deploy the floating user plane function in the area in response to the detecting of the trigger condition, where the floating user plane function is hosted on at least one host mobile communication device that is in communication with the processing system. The processing system may then assign at least one protocol data unit session for at least a first user equipment to the floating user plane function.

In one example, the present disclosure discloses a device, computer-readable medium, and method for performing a data communication with a remote network via a floating user plane function for the at least one protocol data unit session for at least one user equipment. For instance, a processing system including at least one processor of a first user equipment may obtain an instruction to activate at least a portion of a floating user plane function, where the floating user plane function is hosted on at least one host mobile communication device, and where the at least one host mobile communication device comprises the first user equipment. The processing system may then obtain assignment of at least one protocol data unit session for at least one user equipment to the floating user plane function and may perform at least one of: transmitting data to or receiving data from a data network via the floating user plane function for the at least one protocol data unit session for the at least one user equipment.

In one example, the present disclosure discloses a device, computer-readable medium, and method for performing a data communication with a remote network via a floating user plane function for at least one protocol data unit session for a first user equipment. For instance, a processing system including at least one processor of a first user equipment may obtain from a session management function of a cellular network, a notification indicating an assigning of at least one protocol data unit session for the first user equipment to a floating user plane function, where the floating user plane function is hosted on at least one host mobile communication device. The processing system may then perform a data communication with a data network via the floating user plane function for the at least one protocol data unit session, where the data communication via the floating user plane function is via a cellular sidelink between the first user equipment and the at least one host mobile communication device.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example of a cellular network that may include a plurality of cell sites, a plurality of floating user plane functions, and a plurality of user equipment;

FIG. 3 illustrates examples of protocol data unit sessions, e.g., in a 5G cellular network, including examples of the use of floating user plane functions in accordance with the present disclosure;

FIG. 4 illustrates a flowchart of an example method for assigning at least one protocol data unit session for at least one user equipment to a floating user plane function;

FIG. 5 illustrates a flowchart of an example method for performing a data communication with a remote network via a floating user plane function for the at least one protocol data unit session for at least one user equipment;

FIG. 6 illustrates a flowchart of an example method for performing a data communication with a remote network via a floating user plane function for at least one protocol data unit session for a first user equipment; and

FIG. 7 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and devices for assigning at least one protocol data unit session for at least one user equipment to a floating user plane function; methods, computer-readable media, and devices for performing a data communication with a remote network via a floating user plane function for the at least one protocol data unit session for at least one user equipment; and methods, computer-readable media, and devices for performing a data communication with a remote network via a floating user plane function for at least one protocol data unit session for a first user equipment.

For instance, in existing 5G architectures, user plane functions (UPFs) may sit behind the radio access network (RAN) (e.g., a gNodeB or gNB), which sits between user equipment (UE(s)) and the core network. In this case, a UE may first have to connect to the RAN, and the RAN may relay the traffic to the UPF, which may incur delay. In addition, existing 5G architectures may generally employ two main models of UPF utilization: one UPF for the whole communication session, no matter how far a UE moves during the session, or instead a UE may be assigned to UPFs as the UE moves and may: (a) connect to a new UPF before disassociating from a prior UPF or (b) connect to a new UPF after disconnecting from a prior UPF.

In contrast, examples of the present disclosure describe a floating user plane function (a floating UPF, or F-UPF), which may comprise a thin intelligent layer that sits between one or more UEs and a RAN. In one example, a floating UPF may enable data traffic to be exchanged directly from the RAN to an external data network (DN)/remote network (RN) (e.g., without specific routing to one or more other UPFs for further processing). The floating UPF is very near to a UE and in a sense, it hovers and shadows the UE as the UE may move about in an area. In one example, the floating UPF is a distributed system that resides on multiple UEs (e.g., portions, or fragments of the UPF may include pieces of UPF code that run on processing systems of separate UEs, but may be in local wireless communication with each other and may collectively serve as a UPF). For instance, a floating distributed UPF may be assigned to cover a certain area and may reside in the computing systems of moving cars, edge nodes, UEs, etc. In one example, fragments may comprise virtual machines (VMs), containers, or the like, that may be deployed to and/or activated within the participant device/host communication sub-system. In one example, a floating UPF and/or fragment(s) thereof are not accessible to the user. Rather, a floating UPF and/or fragment(s) thereof is/are controlled by the network (e.g., instantiated and de-instantiated by the network, configured with quality of service (QOS) and other rules as defined by the network, and so forth).

In one example, amongst the distributed portions of a floating UPF, there may be a single fragment that functions as a controller. For example, a single floating UPF may comprise three fragments: two residing on different vehicles in the area and one fragment residing on a mobile smartphone. In one example, a floating UPF may deactivate itself if there are no active UEs in the floating UPF's assigned geographical area. Conversely, a floating UPF may be activated, or instantiated, and/or “spun up” by the cellular network if there are UEs heading towards the area. In one example, a floating UPF may be in continuous communication with cellular core network components (e.g., a session management function (SMF), other non-floating UPFs, etc.).

In one example, when a UE is anticipated to be approaching an area assigned to a floating UPF, the floating UPF may be notified of the UE and one or more of the UE's PDU sessions such that the floating UPF may establish a parallel session (or sessions) to one or more remote hosts/servers that the UE is connected to via a PDU session served by a current UPF (floating or non-floating). Accordingly, when the UE is in the assigned area of the next floating UPF, the PDU session(s) may be handed off seamlessly. Similar to a non-floating UPF, a floating UPF may function as an advanced routing layer that establishes full connection from a UE to a web server. However, the floating UPF may move data traffic for one or more of the UE's PDU sessions to the RAN and to the web server directly (e.g., bypassing the core network UPFs). In addition, a floating UPF may obtain policies and/or a profile (e.g., including quality of service (QOS), etc.) pertaining to the user/UE that may be obtained from a home UPF and/or from an SMF, or other core network components.

In one example, a floating UPF of the present disclosure may reside entirely or primarily with the computing systems/processing systems of one or more network-connected vehicles. For instance, each vehicle may possess several or all software portions (also referred to herein as segments or fragments) of a single UPF, which may comprise a light-weight software application. In one example, all or a portion of the vehicles in a geographic area may be configured to provide a full floating UPF (where all the different software segments work together via peer to peer wireless communication, such as a via a 5G sidelink). It should be noted that although illustrative examples may relate to network-connected vehicles (e.g., with respect to delivery of infotainment, etc.), in other, further, and different examples, a floating UPF of the present disclosure may extend to include individual UEs. In addition, although floating UPFs may provide services in connection with infotainment for network-connected vehicles, in other, further, and different examples, floating UPFs may provide services in connection with various types of usage, such as for vehicle sensors, Internet of Things (IoT) devices in an area, and so forth.

In one example, a UE may initiate a session similar to existing 5G registration and signaling. For instance, an initial network-based (non-floating) UPF may be assigned to the PDU session. Then, as the UE moves away from the initial UPF (e.g., which may be indicated by attachment to new RAN/base station(s)), the PDU session may be assigned/transferred to a floating UPF for the UE's location and/or along a route (or a predicted route) of the UE. To illustrate, in one example, the transfer may be initiated by a SMF or the initial UPF, which may obtain current UE location information, such as from a vehicle GPS, and prepare the floating UPF along the UE's route in advance. In one example, a floating UPF may be automatically constructed based on certain locations such as a bus route, convention centers, stadiums, and so forth. Similarly, a floating UPF may be automatically constructed based on certain events and timing (such as when a major sporting event at a stadium, arena, or the like is ending and spectators are leaving). Conversely, if there is low usage in an area, the network may select to proceed with a traditional UPF architecture.

In one example, a floating UPF may be instantiated and/or assigned to a certain class or classes of users, UEs, application(s), etc. Thus, for example, the network may select between a floating UPF and non-floating UPF, and/or between two or more floating UPFs based on the application(s) being used. In one example, the network may add a floating UPF in an area into which one or more UEs will be travelling toward so that floating UPF is ready when the UE(s) arrive. In one example, the floating UPF may engage in load balancing among core UPFs (e.g., where one or more may stay within a path of a PDU session), or can select to bypass core UPFs entirely.

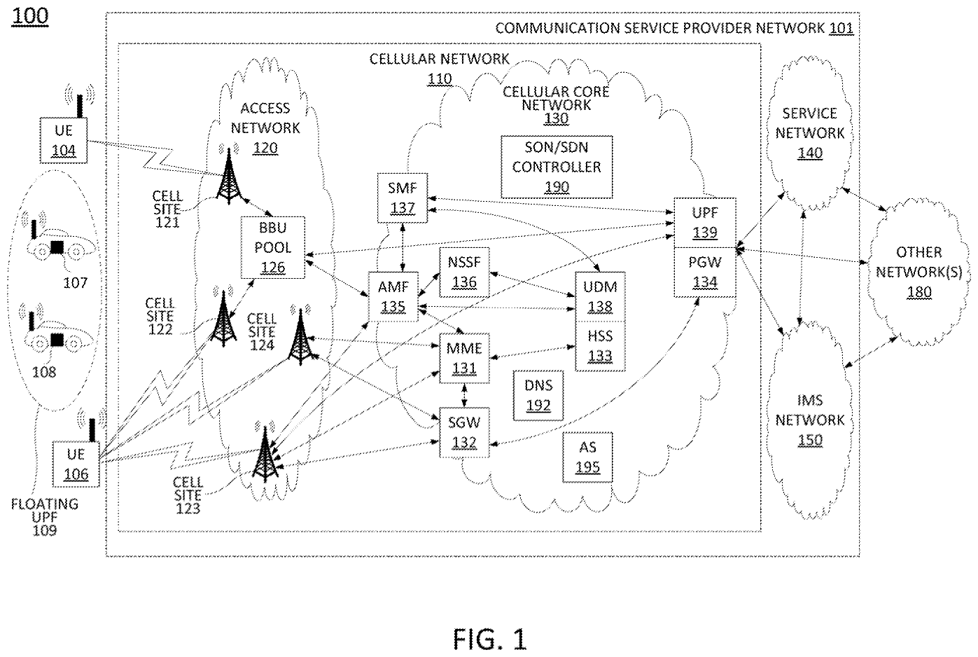

It should be noted that although examples herein are described primarily in connection with a 5G cellular network, other, further, and different examples may relate to a 4G/LTE network, 6G cellular network, or the like. For example, 3GPP New Radio (NR) and/or 5G radio access technologies operate in the centimeter and millimeter wave frequency band. In one example, millimeter wave (mmWave) spectrum (e.g., spectrum with carrier frequencies between 30 and 300 GHz), is attractive for wireless communications systems since available transmission bandwidth roughly scales with the carrier frequency. However, the coupling loss between a transmitter and a receiver also scales as a function of the transmission bandwidth due to the larger thermal noise floor. In order to overcome the coupling loss at high carrier frequencies, and also because the antenna apertures are much smaller at higher frequencies, antenna arrays with a large number of antenna elements are employed in mmWave communications systems. In addition, these antenna arrays are used to electrically steer transmissions into a certain direction (also known as beamforming) by co-phasing the waveforms of the various antenna elements. The beamformed nature of such a wireless communications system complicates its design and operation. In contrast, LTE/4G radio access networks are omni-directional wireless communications systems and may have a greater range given the same transmit power. Thus, deployments of 5G radio access infrastructure may not fully supplant or make obsolete existing and yet to be deployed 4G/LTE infrastructure. These and other aspects of the present disclosure are discussed in greater detail below in connection with the examples of FIGS. 1-7.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks. In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures (or any other future infrastructures such as 6G) and technologies, and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QOS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices. It should be noted that in accordance with the present disclosure, UPF 139 may comprise a “non-floating”/network-based UPF.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. For instance, for a hybrid, or integrated 4G/LTE-5G cellular core network such as cellular core network 130, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) (broadly, a “data network” (DN)) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular core network 130 may also include a self-optimizing network (SON)/software defined network (SDN) controller 190. In one example, SON/SDN controller 190 may function as a self-optimizing network (SON) orchestrator that is responsible for activating and deactivating, allocating and deallocating, and otherwise managing a variety of network components. For instance, SON/SDN controller 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SON/SDN controller 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SON/SDN controller 190 may be connected directly or indirectly to any one or more network elements of cellular core network 130, and of the system 100 in general. Due to the relatively large number of connections available between SON/SDN controller 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. UEs 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In addition, FIG. 1 illustrates, vehicle on-board units (OBUs) 107 of 108, which may comprise vehicle computing/processing system(s) that may include a variety of components, such as a navigation system, a diagnostics system, an entertainment system, a dashboard camera, and so forth. In one example, each of the OBUs 107 and 108 may comprise one or more radio frequency (RF) transceivers for cellular communications and/or for non-cellular wireless communications, such as dedicated short range communication (DSRC), IEEE 802.11-based communications, etc. The OBU 107 and OBU 108 of each vehicle may also be equipped to communicate with other OBUs. For instance, in general, DSRC networks enable wireless vehicle-to-vehicle (V2V) communications and vehicle-to-infrastructure (V2I) communications. Similarly, in one example, OBUs 107 and 108, UEs 104 and 106, and others may communicate with each other directly using an LTE sidelink, a 5G sidelink, or the like. In accordance with the present disclosure OBUs, such as OBUs 107 and 108, may also comprise, and may also be referred to as “user equipment.”

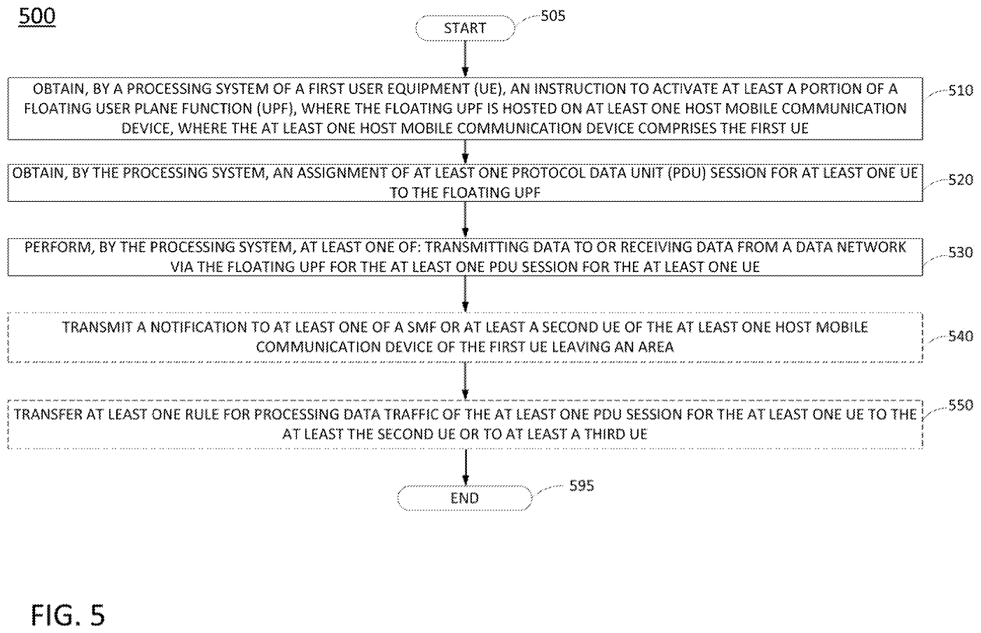

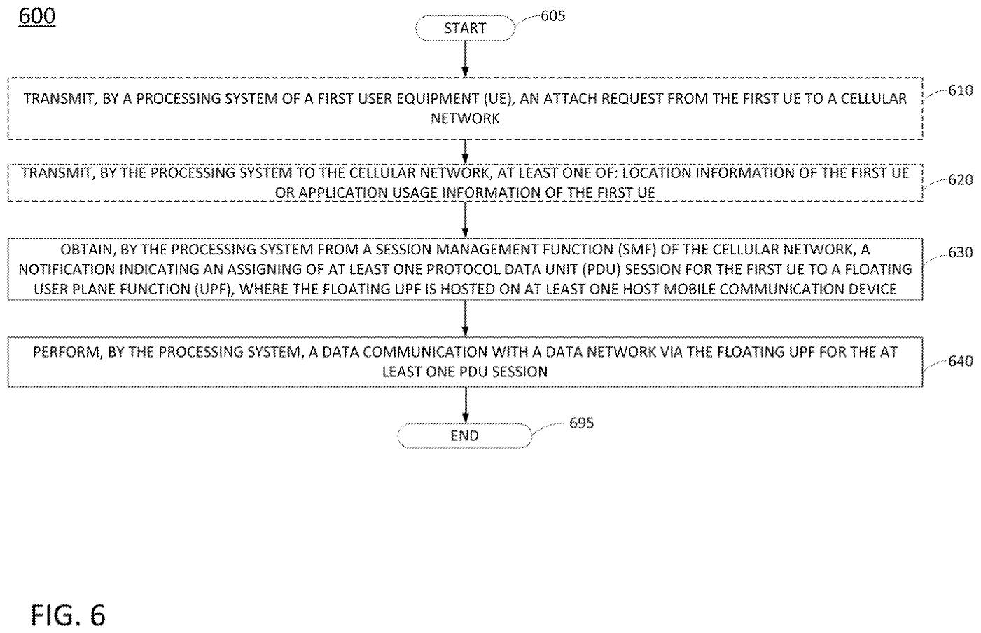

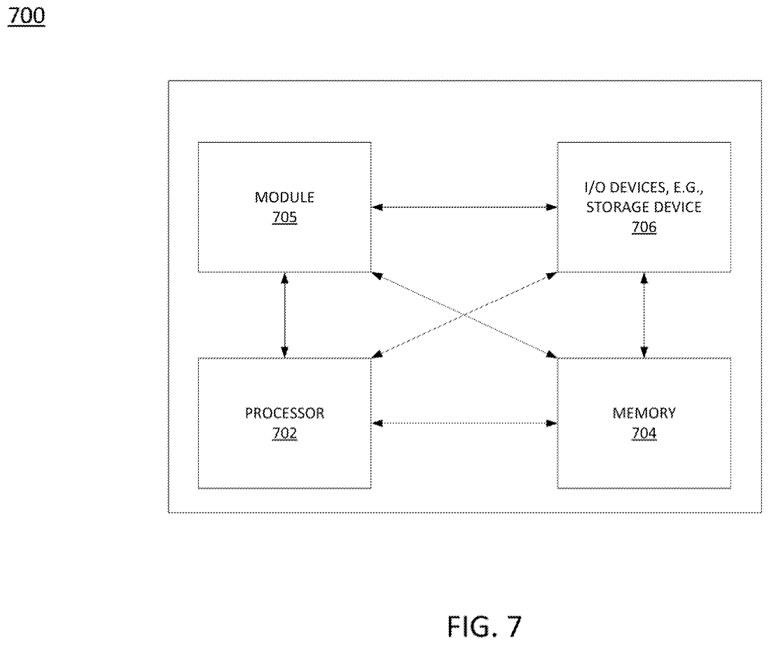

In one example, each of the UE 104, UE 106, OBU 107, and/or OBU 108 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104, UE 106, OBU 107, and/or OBU 108 may also include a gyroscope and compass to determine orientation(s), a global positioning system (GPS) receiver for determining a location, and so forth. In addition, in one example, each of the UE 104, UE 106, OBU 107, and/or OBU 108 may comprise all or a portion of a computing device or system, such as computing system 700, and/or processing system 702 as described in connection with FIG. 7 below, and may be configured to provide one or more functions in connection with examples of the present disclosure for, methods, non-transitory computer-readable media, and apparatuses for performing a data communication with a remote network via a floating user plane function for the at least one protocol data unit session for at least one user equipment (e.g., as illustrated and described in connection with the example of FIG. 5) and/or for performing a data communication with a remote network via a floating user plane function for at least one protocol data unit session for a first user equipment (e.g., as illustrated and described in connection with the example of FIG. 6). In one example, OBUs 107 and 108 may individually or collectively operate as a floating user plane function (UPF) (e.g., floating UPF 109), as described herein.

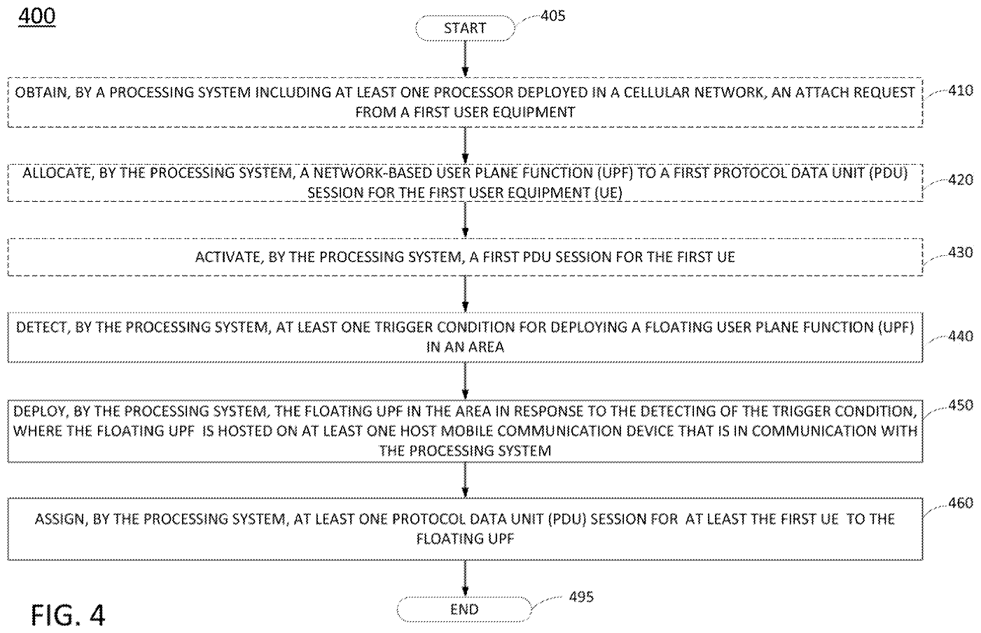

In addition, aspects of the present disclosure for assigning at least one protocol data unit session for at least one user equipment to a floating user plane function, e.g., as described in greater detail below in connection with the example method 400 of FIG. 4, may be performed by SMF 137, AMF 135, and/or SMF 137 in conjunction with AMF 135 and/or one or more other components, such as NSSF 136, and so forth. However, in another example, aspects of the present disclosure for assigning at least one protocol data unit session for at least one user equipment to a floating user plane function may alternatively or additionally be provided via another device, such as SON/SDN controller 190, a dedicated device such as application server (AS) 195, and so forth. In this regard, it should be noted that in one example, AS 195 may comprise an application function (AF) in accordance with 5G cellular core network component designations. However, in accordance with the present disclosure, AS 195 may also be in communication with 4G network components. For ease of illustration, links between AS 195 and various other network elements are omitted from FIG. 1. In accordance with the present disclosure, each of the SMF 137, AMF 135, SON/SDN controller 190, and/or AS 195 may comprise all or a portion of a computing device or system, such as computing system 700, and/or processing system 702 as described in connection with FIG. 7 below, and may be configured to perform various operations in connection with assigning at least one protocol data unit session for at least one user equipment to a floating user plane function, e.g., as described in greater detail below in connection with the example method 400 of FIG. 4.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 7 and discussed below) or multiple computing devices collectively configured to perform various steps, functions, and/or operations in accordance with the present disclosure.

As illustrated in FIG. 1, UE 104 may access wireless services via the cell site 121, while UE 106 may access wireless services via any of cell sites 122-124 located in the access network 120. In one example, UE 106 may request service discovery via 4G radio access infrastructure for accessing a packet data network (PDN) (e.g., one of service network 140, other networks 180, or IMS network 150). For instance, the UE 106 may utilize an LTE radio to transmit the request to MME 131 via cell site 124 (e.g., an eNodeB). The MME 131 may then establish a session to enable communications between the UE 106 and the PDN.

In one example, the session may be established by forwarding the service discovery request to a domain name server (DNS) 192 to correlate the service discovery request with an appropriate access point name (APN) for the PDN. For ease of illustration, various links between DNS 192 and other components of cellular core network 130 are omitted from FIG. 1. The MME 131 may also obtain subscriber information relating to the endpoint device from HSS 133. The subscriber information may include policies, restrictions, authorizations, and the like which may affect which network components are selected to handle the session, the quality of service (QOS) to be provided via the components, and so forth. In accordance with the subscriber information, MME 131 may select a PGW, e.g., PGW 134, for accessing the PDN based upon the APN, and may configure an SGW, e.g., SGW 132, the cell site 124, and the PGW 134 to handle traffic between UE 106 and the PDN. In other words, a session via 4G radio access infrastructure may be initially established to handle the access of the UE 106 to the PDN. In one example, in accordance with the present disclosure, MME 131 may also notify a 4G/5G interworking device (e.g., AS 195 and/or AMF 135) of the registration of UE 106 and the activation of the session via SGW 132 and PGW 134. The interworking device may comprise a dedicated device (e.g., AS 195) or may comprise a 5G core network (CN) component, such as AMF 135.

Alternatively, or in addition, in one example, UE 106 may connect to a 5G new radio (NR), or gNodeB (gNB), and send a request to activate a session (e.g., a PDU session). For instance, UE 106 may connect to cell site 122 or to cell site 123. It should be noted that in one example, UE 106 may establish and maintain connections to the cellular core network 130 via multiple gNBs. However, for illustrative purposes, the present example is described where UE 106 connects to a single gNB (e.g., cell site 122, or cell site 122 in conjunction with baseband processing unit(s) from BBU pool 126).

In one example, the request may include various endpoint device context data with an indication that the session is a new session, a handover session, etc. Cell site 122/BBU pool 126 may forward the request to AMF 135. In a 4G-to-5G handover, AMF 135 may forward the endpoint device context data to MME 131 for key verification. MME 131 may return an affirmative response to AMF 135 when there is a match. In another example, AMF 135 may obtain control plane data, such as network-based session context data (e.g., including session key(s)) from MME 131 to verify against the endpoint device context data. When verified, the endpoint device context data may then be used to establish the session via the 5G radio access infrastructure and to provide continuity with respect to a state of a service between UE 106 and the PDN. For both a handoff or for a new session, AMF 135 may engage SMF 137 and UPF 139 according to a response from NSSF 136. For instance, SMF 137 and UPF 139 may be configured to handle the traffic between UE 106 and the PDN via cell site 122 and BBU pool 126. In one example, AMF 135 may also engage a different AMF if the different AMF is part of the network slice that is assigned. However, for illustrative purposes, it is assumed that AMF 135 handling the establishment of the session remains part of the session once established. In one example, the configuration of SMF 137 and/or UPF 139 may also involve providing state information that AMF 135 may obtain from UE 106 and/or from MME 131. In addition, the portion of BBU pool 126 assigned for cell site 122 may be configured via a command from the AMF 135 to direct traffic to and receive traffic from UPF 139 for communications between UE 106 and the PDN.

In one example, cellular network 110 may monitor a variety of conditions relating to the UE 106, the service, and network conditions to determine if and when to transfer the access of UE 106 to the PDN from a network-based UPF (e.g., UPF 139) to a floating UPF (e.g., floating UPF 109). For instance, cellular network 110 may detect various triggering conditions relating to time, endpoint device location, user preference, type of service, service conditions, network conditions, and/or device capability that may cause cellular network 110 to transfer the access of UE 106 to the floating UPF 109. For instance, SMF 137, AMF 135, and/or AS 195 may be configured by a network operator with respect to various thresholds regarding the various trigger conditions, specific combinations of trigger conditions, and so forth. To illustrate, in one example, AS 195 may be in communication with a variety of devices in cellular core network 130, access network 120, or other portions of cellular network 110 to obtain measurements, flags, statistics, and other data pertaining to the variety of trigger conditions. For instance, AS 195 may obtain a number of current session threads, a number of assigned and/or available ports, and so forth from AMF 135. In one example, AS 195 may obtain memory utilization, processor idle time, peak processor utilization, free capacity, and other measurements from AMF 135, SMF 137, UPF 139, and so on (or from the NFVI/host device(s) underlying these various network functions). In one example, when AS 195 determines that the access of UE 106 to the PDN should be transferred to floating UPF 109, AS 195 may signal to SMF 137 to initiate a handoff. AS 195, SMF 137, and/or AMF 135 may also engage NSSF 136 to determine a network slice of the 5G “next-generation” (NG) core to select the floating UPF 109.

In one example, cellular network 110 may continue to monitor a variety of conditions relating to UE 106, the service, and network conditions to determine if and when to transfer the access of UE 106 to the PDN to a different floating UPF and/or to another network-based UPF. For instance, cellular network 110 may detect various triggering conditions relating to time, endpoint device location, user preference, type of service, service conditions, network conditions, and/or device capability that may cause cellular network 110 to transfer the PDU session. In one example, AS 195 may be configured by a network operator with respect to various thresholds regarding the various trigger conditions, specific combinations of trigger conditions, and so forth for such transfers. In one example, the thresholds for reverting to a network-based PDU may be set in relation to the thresholds for switching from a network-based PDU to a floating PDU. For instance, certain differentials for the threshold(s) for network-based PDU to floating PDU transfers and for floating PDU to network-based PDU transfers may be set such that rapid cycling is avoided.

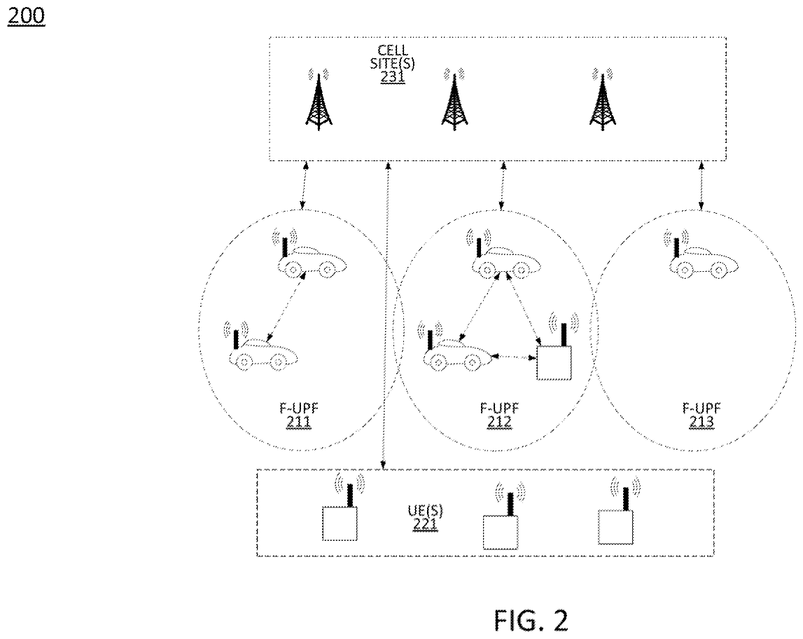

In one example, cellular network 110 may signal to UE 106 via AMF 135 and cell site 122 to transfer to a floating UPF PDU session. For instance, SMF 137 may provide identification information of the floating UPF 109 to UE 106 via AMF 135 and cell site 122. In one example, the identification information may include an identifier of the floating UPF 109 and/or one or more host systems comprising the floating UPF 109, e.g., identifier(s) of OBU 107 and/or OBU 108. As noted above, each of the UE 104, UE 106, OBU 107, and/or OBU 108 may comprise all or a portion of a computing device or system, such as computing system 700, and/or processing system 702 as described in connection with FIG. 7 below, and may be configured to provide one or more functions in connection with examples of the present disclosure for performing a data communication with a remote network via a floating user plane function for the at least one protocol data unit session for at least one user equipment (e.g., as illustrated and described in connection with the example of FIG. 5) and/or for performing a data communication with a remote network via a floating user plane function for at least one protocol data unit session for a first user equipment (e.g., as illustrated and described in connection with the example of FIG. 6). In this regard, example operations and other aspects of a floating UPF are described in greater detail below in connection with the examples of FIGS. 2-7.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates an example 200 in which a cellular network may include a plurality of cell sites 231, which may be in communication with a plurality of floating UPFs (F-UPFs) 211-213 and a plurality of user equipment (UEs) 221. For instance, a cellular network may assign one or more of UEs 221 to one or more of the floating UPFs 211-213. Each of the floating UPFs 211-213 may be assigned to and therefore associated with a designated area. As noted above, a floating UPF may comprise distributed system that resides on multiple UEs (e.g., portions, or fragments of the UPF may include pieces of UPF code that run on processing systems of separate UEs (e.g., different vehicle OBUs, different mobile smartphones, etc.), which may be in local wireless communication with each other and may collectively serve as a UPF. Thus, for example, floating UPF 211 may comprise fragments on two vehicles (e.g., the OBUs thereof). Similarly floating UPF 212 may comprise fragments on two vehicles and on one UE/smartphone. On the other hand, floating UPF 213 may be hosted on a single vehicle/OBU. In one example, a floating UPFs may be in continuous communication with cellular core network components (e.g., a session management function (SMF), other non-floating UPFs, etc. (not shown)) via one or more cell sites 231.

In one example, UEs hosting fragments of F-UPFs 211-213 may agree to serve as hosts for compensation or service discounts, to obtain faster service (priority), and so forth. In one example, a single fragment of one of F-UPFs 211-213 may control other fragments of the same F-UPF. To illustrate, the controller fragment may detect participating UE hosts in the vicinity and may identify which ones have capacity (e.g., bandwidth, processor capacity, memory capacity, CPU, power and/or charge, and so forth) to host fragments of a floating UPF. In addition, for an existing floating UPF, the controller fragment may observe which participating host UEs move out of the area or are predicted to be moving out of the area, and may assign other present and available UE hosts to host that fragment. In one the controller may calculate the direction and speed of the host UE and estimate how long it will stay in the coverage area before assigning the fragment to the host UE. Alternatively, or in addition, the controller may take over the functions of the fragment. In one example, the controller may be responsible for routing data traffic of a PDU session between one of the UEs 221 and the RAN (e.g., one or more of cell sites 231).

In one example, the F-UPFs 211-213 may be assigned to serve the various UEs 221 that may move throughout a region of a cellular network covered by one or more of the cell sites 231. For instance, one of the UEs 221 may be moving in a direction such that the UE may travel from a coverage area of F-UPF 211 to F-UPF 212 and finally to F-UPF 213. In one example, the one of the UEs 221 may be handed off from F-UPF 211 to F-UPF 212, and from F-UPF 212 o F-UPF 213, and so on. Alternatively, or in addition, one of the F-UPFs 211-213 may comprise one or more fragments operating on moving vehicles and/or other UEs, such that the one of the UEs 221 being served may move along within one of the F-UPFs 211-213 (at least for a time) coverage area. In one example, a handoff may be initiated by a UE 221 being served by one of the F-UPFs 211-213, by one of the F-UPFs 211-213, by an SMF that may monitor one or more PDU sessions for the one of the UEs 221, and so forth.

It should also be noted that a PDU session may be handed off from one of F-UPFs 211-213 to a non-floating, network-based UPF. For instance, a UE 221 may move from an area having a designated F-UPF to an area that does not have a currently operating F-UPF. In addition, the new area may have a relatively low demand such that the cellular network may determine that the instantiation of a new floating F-UPF is now warranted. Thus, the PDU session(s) for a UE 221 may be transitioned to a non-floating, network-based UPF. It should also be noted that in addition to F-UPFs 211-213 serving UEs 221, F-UPFs 211-213 may also serve PDU sessions for vehicle OBUs or other UEs that host F-UPFs 211-213 (or fragments thereof). In one example, host UEs may preferentially comprise vehicle OBUs, while mobile smartphones or other UEs may be assigned fragments in certain circumstances, such as for large conventions, major sporting events, and so forth.

In one example, the network may determine that a floating UPF should be instantiated based on one or more rules. For instance, if an increase in network traffic (e.g., determined via network probes or the like) is anticipated to impact QoS, then the network may command the nearest RAN (e.g., one or more of cell sites 231) to activate and/or to instantiate a floating-UPF. In one example, cell site(s) 231 can spin up a traffic-type specific floating UPF (e.g., to support video streaming of a popular sporting event, or the like, which may be known to the network based upon a specific destination server, or group of destination servers, IP addresses, and/or uniform resource locators (URLs), etc.). Alternatively, or in addition, a floating UPF may be group-specific, such as for employees of a certain company, or to cover a work building, etc. Accordingly, any one or more of the F-UPFs 211-213 may be event-specific, application-specific, or group-specific, and so forth.

In one example, vehicles and other UEs may be notified along their routes of upcoming floating UPFs (e.g., F-UPFs 211-213) and the options regarding connecting thereto. For instance, in one example, a list of upcoming floating UPFs may be published for a larger geographical area (e.g., via cellular broadcast, or the like). In one example, a moving UE (e.g., a vehicle OBU) may anticipate when it has or will lose connection to a current floating UPF based on the area/geographic information for the floating UPF obtained when the UE initially connected to the floating UPF and/or based upon a published list of floating UPFs. As such, the UE may send an alert to the nearest RAN of an impending disconnection from a current floating UPF. In one example, the UE may establish a new tunnel to a new floating UPF before it disconnects from the current one. Thus, two simultaneous connections may be maintained for a limited time. In one example, once the new UE-to-floating UPF connection is stable and functioning, the connection to the old floating UPF may be torn down.

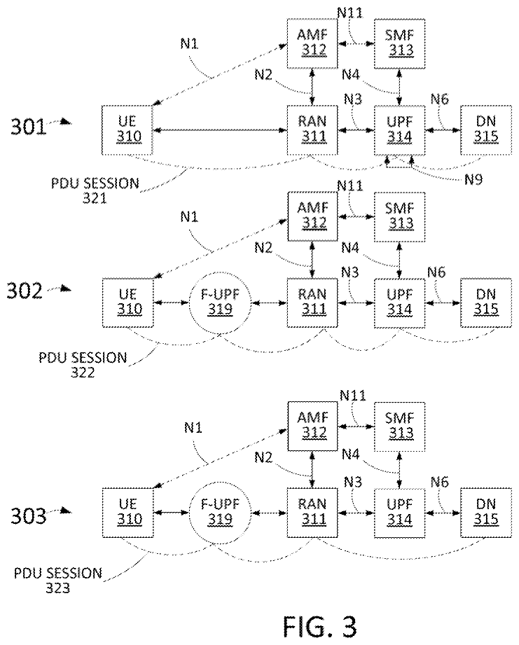

To further aid in understanding the present disclosure, FIG. 3 illustrates examples of PDU sessions, e.g., in a 5G cellular network, including examples of the use of floating UPFs in accordance with the present disclosure. For instance, in a first example 301, cellular network components may include RAN 311 (e.g., a base station, such as gNB), access management function (AMF) 312, session management function (SMF) 313, and user plane function (UPF) 314. These components may establish one or more PDU sessions for a UE 310 to a remote network, e.g., data network (DN) 315. Relevant interfaces relating to UPF 314 include N3, N4, and N6 interfaces. For instance, the N3 interface may comprise a connection between RAN 311 and network-based UPF 314, the N4 interface may comprise a connection between SMF 313 and UPF 314, and the N6 interface may represent a connection between the UPF 314 and DN 315.

In addition, the N9 interface may represent a connection between two UPFs, e.g., an intermediate UPF (I-UPF) and a session anchor UPF. Thus, in one example, UPF 314 may represent multiple network-based UPFs. The N1 interface may comprise a reference point between the UE 310 and the AMF 312. In addition, the N2 interface may comprise a reference point between the RAN 311 and the AMF 312. Other interfaces/reference points may include an N11 interface between AMF 312 and SMF 313, an interface between AMF 312 and a network slice selection function (NSSF) (not shown), and so forth. Notably, example 301 illustrates a PDU session 321 connecting UE 310 to DN 315 (e.g., a server or other computing systems within the DN 315). For instance, PDU session 321 may include a data radio bearer (DRB) between UE 310 and RAN 311, a tunnel between RAN 311 and UPF 314 (e.g., a general packet radio service (GPRS) tunneling protocol (GTP) tunnel, e.g., in accordance with GTP-U for user plane tunneling, or the like) and another tunnel from UPF 314 to DN 315, e.g., an HTTPS tunnel, an IPSec tunnel, or the like. It should be noted that each of these hops may comprise bi-directional links or pairs, e.g., uplink and downlink DRB pairs, bidirectional tunnels or pairs of unidirectional tunnels, etc.

Example 302 illustrate the same components as example 301. In addition, example 302 further illustrates a floating UPF (F-UPF) 319 that is instantiated and which operates between the UE 310 and the RAN 311. In this case, a PDU session 322 for UE 310 may include a sidelink data radio bearer (SL-DRB) between UE 310 and F-UPF 319, a tunnel between F-UPF 319 and UPF 314 (e.g., GTP-U) (or a DRB between F-UPF 319 and RAN 311 and a GTP-U tunnel between RAN 311 and UPF 314), and an HTTPS tunnel, an IPSec tunnel, or the like between UPF 314 and DN 315. In this case, F-UPF 319 is situated closer to UE 310 and may advantageously provide faster UPF services to UE 310 (e.g., QoS enforcement, etc.). However, UPF 314 may remain in the data path of PDU session 322 and continue to operate as either a session anchor UPF or an intermediate UPF (I-UPF). In one example, F-UPF 319 may select a “best” network-based UPF (e.g., UPF 314) to include in the PDU session 322, and may also select if and when to transition the PDU session 322 to another network-based UPF. For instance, in one example, a security policy may provide criteria for F-UPF 319 to decide which traditional/core UPF (e.g., UPF 314) to select. In an example in which PDU session 322 is a new session, F-UPF 319 may make such a selection before the UE 310 connects to the RAN 311. More generally, F-UPF 319 may select a network-based (non-floating UPF), e.g., UPF 314, that is closest, or further away depending on load, security preferences and/or requirements, one or more other policies/rules, user profiles, and so forth.

Example 303 illustrates the same components as example 302. However, in this case, UPF 314 is not in the path of PDU session 323. Instead, in example 303, the F-UPF 319 may connect directly to DN 315 (e.g., without additional UPFs, such as UPF 314, in the data path). Thus, in example 303, PDU session 323 may include a sidelink data radio bearer (SL-DRB) between UE 310 and F-UPF 319, and an HTTPS tunnel, an IPSec tunnel, or the like between F-UPF 319 and DN 315. It should be noted that examples 302 and 303 therefore provide two different architectures for PDU session paths via a floating UPF in accordance with the present disclosure.

In one example, F-UPF 319 may be assigned an identifier, or the host systems of F-UPF 319 (e.g., one or more vehicle OBUs and/or other UE(s)) may be assigned identifiers such that UE 310 may address sidelink communications to the F-UPF 319. In one example, the identifier may be provided by the AMF 312 (and/or by the SMF 313 via the AMF 312). In an example in which F-UPF 319 may comprise distributed fragments, the host UEs may maintain secure wireless broadcast sessions or peer-to-peer sessions with each other, e.g., via 5G sidelink(s). In one example, the host UEs may maintain one or more GTP sessions for control signaling (e.g., GTP-C) and or SL-DRBs with each other.

In various examples, a cellular network may select whether and when to instantiate floating UPFs, when to assign UE PDU sessions to floating UPFs, and which types of PDU sessions to establish (e.g., such as in accordance with example 302 and/or example 303 of FIG. 3). In various examples, the selections may be made using various programmed rules and based on various criteria/input factors such as: time of day, day of the week, individual UE utilization metrics and/or collective metrics of UEs in an area, subsets of UEs (e.g., by make, model, etc.), by application usage for specific applications, based on the occurrence of events of one or more defined event types and/or scheduled events, user preferences, UE class (e.g., first responder, governmental account, etc.), and so forth. In various examples, assigning a PDU session for UE 310 to F-UPF 319 may be for a new PDU session and/or for a handover PDU session. These and other aspects of the present disclosure are described in greater detail below in connection with the examples of FIGS. 4-6.

FIG. 4 illustrates a flowchart of an example method 400 for assigning at least one protocol data unit session for at least one user equipment to a floating user plane function, in accordance with the present disclosure. In one example, steps, functions and/or operations of the method 400 may be performed by a device as illustrated in FIG. 1, e.g., SMF 137, AMF 135, AS 195, or any one or more components thereof, such as a processing system, or collectively via a plurality devices in FIG. 1, such as SMF 137 in conjunction with AMF 135, AS 195 in conjunction with AMF 135 and/or SMF 137, and in some examples further in conjunction with UPF 139, any one or more of cell sites 121-124, and so forth. In one example, the steps, functions, or operations of method 400 may be performed by a computing device or system 700, and/or a processing system 702 as described in connection with FIG. 7 below. For instance, the computing device 700 may represent at least a portion of SMF 137, AMF 135, and/or AS 195 in accordance with the present disclosure. For illustrative purposes, the method 400 is described in greater detail below in connection with an example performed by a processing system. The method 400 begins in step 405 and may proceed to optional step 410 or to step 440.

At optional step 410, the processing system (deployed in a cellular network) may obtain an attach request from a first UE. The attach request may comprise an initial attach request or a handover request (e.g., from one cell site to another). In one example, the handover request may be a 4G to 5G handover request.

At optional step 420, the processing system may allocate a network-based user plane function (UPF) (e.g., a non-floating UPF) to a first protocol data unit (PDU) session for the first UE. For instance, in one example, the processing system may comprise an SMF, which may select the UPF based on information from a network slice selection function (NSSF) and/or in accordance with other rules/policies.

At optional step 430, the processing system may activate the first PDU session for the first UE. For instance, optional step 430 may include notifying the RAN. In an example in which the processing comprises an SMF, optional step 430 may include notifying an AMF of the allocation of the network-based (non-floating) UPF. For instance, a SMF may activate an N3 link/reference point and instruct a gNB, via the AMF, of which UPF to use.

At step 440, the processing system detects at least one trigger condition for deploying a floating user plane function (UPF) in an area (e.g., an area associated with at least the first UE). For instance, the at least one trigger condition may comprise a load of the UPF (e.g., a non-floating UPF currently serving one or more PDU sessions) exceeding a threshold, a presence of a threshold number of UEs of a designated class (e.g., at least one, 10, 100, etc.) in the area (e.g., first responder, governmental user, etc.), a utilization of an application type or application class via the (non-floating) UPF exceeding a threshold, a predicted load of the (non-floating) UPF exceeding a threshold, a number of connections to one or more particular destination IP addresses, domain names, and/or URLs, and so forth. In other words, a floating UPF may be activated for certain classes of users, types of UE(s), application(s), etc. In one example, the threshold(s) can be static or dynamic (e.g., percentage based, etc.). In one example, utilization may be measured in the number of applications that appear to be in use and/or a traffic volume across the applications over a plurality of UEs that have PDU contexts assigned to the (non-floating) UPF. In one example, predicted demand can be based on scheduled events, time of day, day of week forecasting with time series, and so forth. Alternatively or in addition, the at least one trigger condition may be detected via at least one MLM, e.g., where a binary output of the MLM may indicate whether or not to activate a floating UPF.

It should be noted that as referred to herein a machine learning model (MLM) (or machine learning-based model) may comprise a machine learning algorithm (MLA) that has been “trained” or configured in accordance with input data (e.g., training data) to perform a particular service, e.g., to detect a trigger condition exists/has occurred (and/or to output an action/recommendation to activate a floating UPF), to select whether and when to activate a floating UPF (or vice versa), to select a number of host devices (e.g., for a distributed floating UPF), to select particular host devices from among available UEs that may serve as hosts in an area, and so forth. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, MLMs of the present disclosure may be in accordance with a MLA/MLM template from an open source library, such as OpenCV, which may be further enhanced with domain specific training data. In one example, different MLMs may be trained and deployed for different network zones (e.g., comprising one or more cell sites), different geographic areas of cellular network coverage, e.g., a county, state, etc., and so forth.

At step 450, the processing system deploys the floating UPF in the area in response to the detecting of the trigger condition. As described above, the floating UPF may be hosted on at least one host mobile communication device that is in communication with the processing system. In one example, the at least one host mobile communication device may comprise the first UE. Alternatively, or in addition, the at least one host mobile communication device may comprise one or more OBUs of one or more network-connected vehicles and/or other UEs. In one example, the at least one host mobile communication device may store all or a portion (e.g., a fragment) of instructions, code, or the like for functioning as a floating UPF. In one example, the floating UPF (or fragment thereof) may comprise a virtual machine, container, or the like that may be isolated from an operating system and other aspects of the at least one host mobile communication device that may be accessible to the user. In other words, the floating UPF may comprise a module that is controllable by a network operator (e.g., by the operating system) via remote instructions via the RAN. As such, in one example, the deploying of step 450 may include instructing the at least one host mobile communication device to activate the floating UPF (or fragment thereof) and to begin serving one or more UEs.

In an example in which the at least one host mobile communication device comprises a plurality of host mobile communication devices, the instruction(s) may include instruction(s) for each host mobile communication device to interact with other host mobile communication device(s) hosting other fragment(s). For instance, the processing system may select and assign host mobile communication devices to collectively operate as a floating UPF. The selecting may be based upon various factors such as the type of host mobile communication device (e.g., vehicle OBU, smartphone, etc.), a trajectory of a host mobile communication device, the anticipated duration or time in which the host mobile communication device may remain in an area, the anticipated demand (e.g., relating to an event), time of day, day of the week, etc., and so forth. In one example, the selection of the at least one host mobile communication device, the number of device(s), the types of the devices, and so forth, may be based upon the same or similar factors that may be used in detecting the at least one trigger condition. In addition, in one example, the selection of the host mobile communication devices may be made via at least one machine learning model (MLM). In one example, one of the hosts/fragments may be designated as a controller that may coordinate actions taken among other hosts/fragments.

At step 460, the processing system assigns at least one PDU session for the first UE to the floating UPF. In one example, the at least one PDU session that is assigned to the floating UPF may comprise the first PDU session for the first UE. In such case, step 460 may include transferring the first PDU session for the first UE to the floating UPF. In another example, the at least one PDU session that is assigned to the floating UPF may comprise a second PDU session for the first UE (which may be a new session, or a session being transferred from another UPF (floating or non-floating)). It should be noted that in any case, each PDU session may include a default QoS flow and in some cases, may additionally include a dedicated QoS flow. In one example, the floating UPF implements at least one QoS policy with respect to data traffic of the at least one PDU session between the at least the first UE and at least one data network (DN). In this regard, in one example, step 460 may further include transmitting the at least one QoS policy to the floating UPF.

In one example, step 460 may include transmitting a notification message to the first UE of the assigning of the at least one PDU session for the at least the first UE to the floating UPF. In one example, step 460 may alternatively or additionally include transmitting a notification message to RAN equipment (e.g., a base station) of the assigning of the at least one PDU session for the at least the first UE to the floating UPF. In one example, the transmitting of the notification message(s) may be by the AMF via the SMF, or by the SMF via the AMF. It should again be noted that in various examples, the processing system may comprise an AMF, an SMF, or a network-based UPF, a SON/SDN controller or the like, and so forth. In another example, the processing system may alternatively or additionally comprise a separate application server with logic for instantiating a floating UPF, informing the SMF of the existence of a floating UPF, assigning UEs to the floating UPF, etc. The floating UPF can be assigned to handle the at least one PDU session alone, e.g., with a direct route to destination data network, or can be configured to forward PDU session data to another UPF for forwarding/routing to the destination data network (e.g., an I-UPF). In addition, the floating UPF may pass data traffic of the at least one PDU session between the at least the first UE and at least one data network (e.g., a destination data network (DN), or remote network). In an example in which the at least one host mobile communication device comprises at least one host mobile communication device that is distinct from the first UE, the first UE may connect to the floating UPF via a peer-to-peer, local wireless communication, such as a cellular sidelink (e.g., a 5G sidelink).

In addition, it should be noted that a first UE may cause the floating UPF to be instantiated, or the floating UPF may be instantiated after a threshold number of UEs (e.g., of a given class, application usage, application usage level, etc.) are identified in an area. In one example, new UEs engaging in session setup may still initially connect to a non-floating UPF but may then nearly immediately be directed to the floating UPF. In addition, UEs served by the non-floating UPF may later be offloaded to one or more floating UPFs (e.g., the first 999 UEs/users may be served by a non-floating UPF, but where the 1000^{th} UE may cause a floating UPF to be instantiated, thereby allowing various UEs already present to also be transitioned to the floating UPF).

Following step 460, the method 400 may proceed to step 495 where the method 400 ends.

It should be noted that the method 400 may be expanded to include additional steps or may be modified to include additional operations with respect to the steps outlined above. For example, the method 400 may be repeated through various cycles of detecting trigger conditions for activating floating UPFs, and vice versa. For instance, when a utilization of the floating UPF decreases below a threshold, when a predicted demand drops below a threshold, after a passage of time, etc., the floating UPF may be deactivated/decommissioned via instructions to the one or more host devices. In one example, the method 400 may be expanded to include operations for detecting when one or more of the at least one host device may be exiting an area and reassigning the floating UPF (or a fragment thereof) to one or more other host devices. In one example, the method 400 may be expanded to include detecting that the first UE may be exiting an area assigned to the floating UPF and selecting another UPF (floating or non-floating) to which to transfer one or more PDU sessions previously assigned to the first UE. However, in another example, there may be multiple floating UPFs in an area that may be in communication with each other and which can coordinate handoffs among each other. In one example, the method 400 may be expanded or modified to include steps, functions, and/or operations, or other features described above in connection with the example(s) of FIGS. 1-3, FIG. 5, and/or FIG. 6, or as described elsewhere herein. Thus, these and other modifications are all contemplated within the scope of the present disclosure.

FIG. 5 illustrates a flowchart of an example method 500 for performing a data communication with a remote network via a floating user plane function for the at least one protocol data unit session for at least one user equipment, in accordance with the present disclosure. In one example, steps, functions and/or operations of the method 500 may be performed by a device as illustrated in FIG. 1, e.g., OBU 107, OBU 108, UE 104, or UE 106, or any one or more components thereof, such as a processing system, by a plurality of such device in conjunction with one another, and/or by one or more of such devices in conjunction with one or more additional devices such as AMF 135 and/or SMF 137, UPF 139, any one or more of cell sites 121-124, and so forth. In one example, the steps, functions, or operations of method 500 may be performed by a computing device or system 700, and/or a processing system 702 as described in connection with FIG. 7 below. For instance, the computing device 700 may represent at least a portion of an OBU and/or other UEs in accordance with the present disclosure. For illustrative purposes, the method 500 is described in greater detail below in connection with an example performed by a processing system. The method 500 begins in step 505 and proceeds to step 510.

In step 510, the processing system (e.g., of a first user equipment (UE)) obtains an instruction to activate at least a portion of a floating user plane function (UPF), where the floating UPF is hosted on at least one host mobile communication device, and where the at least one host mobile communication device comprises at least the first UE. In accordance with the present disclosure, the at least the portion of the floating UPF may operate in a non-user-accessible portion of the first UE. For instance, the floating UPF (or a fragment thereof), and in some cases other network service provider functions may reside on the user equipment in Docker engine/container(s), separate VM(s), etc., and may be managed and controlled by an operator of the cellular network.

In step 520, the processing system obtains an assignment of at least one protocol data unit (PDU) session for at least one UE to the floating UPF. In one example, step 520 may include obtaining at least one rule for processing data traffic of the at least one PDU session for the at least one UE. For instance, the at least one rule may include at least one of: a packet detection rule, a forwarding action rule, a buffering action rule, a quality of service (QOS) enforcement rule, a usage reporting rule, and so forth.

In step 530, the processing system performs at least one of: transmitting data to or receiving data from a data network (e.g., a remote network) via the floating UPF for the at least one PDU session for the at least one UE. In one example, the transmitting of the data to or receiving of the data from the data network may be in accordance with the at least one rule that may be obtained at step 520. It should be noted that in one example, the at least one UE may comprise the first UE. In other words, the first UE may comprise the floating UPF (or a portion/fragment thereof) and may serve itself instead of a different UE. In such case, a VM to VM communication interface on the device may enable user applications and one or more segregated network service provider functions (e.g., a floating UPF (or a portion/fragment thereof) and/or other service provider functions to communicate. As such, in one example, the first UE may provide floating UPF services to itself.

In one example, the at least one UE may comprise at least a second UE that does not host a portion of the floating UPF. Accordingly, in one example, the processing system, performing operations of at least a portion of the floating UPF, transmits data to and receives data from the at least the second UE via a cellular sidelink. In one example, the processing system (and/or another fragment of the floating UPF in the case of a distributed, floating UPF) can tunnel to another UPF closer to the destination data network (e.g., a network-based intermediate UPF (I-UPF), or can connect to the destination data network directly (e.g., without involvement of another UPF in the PDU session path).

In optional step 540, the processing system may transmit a notification to at least one of: a SMF or at least a second UE that the at least one host mobile communication device of the first UE is leaving an area, e.g., the area to which the floating UPF may be assigned for providing services to UEs. For instance, the first UE may comprise an OBU of a vehicle that may be traveling along a highway, a smartphone of a user riding in a train, etc., that is anticipated to leave the area in the near future.

In optional step 550, the processing system may transfer at least one rule for processing data traffic of the at least one PDU session for the at least one UE to the at least the second UE or to at least a third UE (e.g., where the at least the third user equipment may take over as the at least one host mobile communication device (or the portion thereof that was associated with the first user equipment)). However, it should be noted that in another example, the at least one rule may not be passed peer-to-peer, e.g., via a sidelink. Rather, for security, an SMF may separately populate the rule(s) that was/were handled by the first UE to the other UE(s).

Following step 530 or either of the optional steps 540 or 550, the method 500 proceeds to step 595 where the method 500 ends.

It should be noted that the method 500 may be expanded to include additional steps or may be modified to include additional operations with respect to the steps outlined above. For example, the method 500 may be repeated through various cycles of being activated (and/or deactivated) as a floating UPF. In one example, the method 500 may be expanded to include operations for detecting when the processing system may be exiting an area and reassigning one or more PDU sessions to one or more other floating UPFs (e.g., other floating UPFs that may be spatially adjacent and/or partially overlapping in assigned area with the floating UPF, etc.). In one example, there may be multiple floating UPFs in an area that may be in communication with each other and which can coordinate handoffs among each other for PDU sessions (e.g., as those UEs being served may move in and out of the areas of floating UPF coverage). In one example, the method 500 may be expanded or modified to include steps, functions, and/or operations, or other features described above in connection with the example(s) of FIGS. 1-4 and/or FIG. 6, or as described elsewhere herein. Thus, these and other modifications are all contemplated within the scope of the present disclosure.

FIG. 6 illustrates a flowchart of an example method 600 for performing a data communication with a remote network via a floating user plane function for at least one protocol data unit session for a first user equipment, in accordance with the present disclosure. In one example, steps, functions and/or operations of the method 600 may be performed by a device as illustrated in FIG. 1, e.g., OBU 107, OBU 108, UE 104, or UE 106, or any one or more components thereof, such as a processing system, or by one of such devices in conjunction with one or more additional devices such as AMF 135 and/or SMF 137, UPF 139, any one or more of cell sites 121-124, and so forth. In one example, the steps, functions, or operations of method 600 may be performed by a computing device or system 700, and/or a processing system 702 as described in connection with FIG. 7 below. For instance, the computing device 700 may represent at least a portion of an OBU and/or other UE in accordance with the present disclosure. For illustrative purposes, the method 600 is described in greater detail below in connection with an example performed by a processing system. The method 600 begins in step 605 and may proceed to optional step 610, optional step 620, or step 630.

In optional step 610, the processing system (e.g., of a first user equipment (UE)) may transmit an attach request from the first UE to a cellular network. For instance, the attach request may be sent to the RAN, e.g. a gNB, eNodeB, or the like, which may be forwarded to an AMF and then to an SMF. However, in another example, the cellular network may initiate a handover of the first UE.

In optional step 620, the processing system transmits, to the cellular network, at least one of: location information of the first UE or application usage information of the first UE.

In step 630, the processing system obtains, from a session management function (SMF) of the cellular network, a notification indicating an assigning of at least one protocol data unit (PDU) session for the first UE to a floating UPF, wherein the floating UPF is hosted on at least one host mobile communication device. In one example, the notification may be in response to the attach request. In one example, the notification may be further in response to the location information and/or the application usage information. For instance, the network may assign the floating UPF based on a current location or a predicted location in accordance with the location information. In one example, the notification may include at least one identifier of the at least one host mobile communication device (e.g., a ProSe ID or other device identifiers that can be used in addressing a sidelink communication to and receiving a sidelink communication from the at least one host mobile communication device).

In step 640, the processing system may perform a data communication with a data network via the floating UPF for the at least one PDU session. In one example, the performing of the data communication at step 640 may utilize the identifier to address the data communication to the floating UPF. In one example, the data communication via the floating UPF is via a peer-to-peer, local wireless communication, such as a cellular sidelink (e.g., a 5G sidelink) between the first UE and the at least one host mobile communication device.

Following step 640, the method 600 proceeds to step 695 where the method 600 ends.

It should be noted that the method 600 may be expanded to include additional steps or may be modified to include additional operations with respect to the steps outlined above. For example, the method 600 may be repeated through various cycles of network attachment and assignments of PDU sessions to floating UPFs, handoffs of PDU sessions from network-based UPFs to floating UPFs, or vice versa, and handoffs of PDU sessions between floating UPFs. In one example, the method 600 may include releasing a previous PDU session after the establishing of a new PDU session (e.g., after the notification of step 630). In one example, the method 600 may be expanded or modified to include steps, functions, and/or operations, or other features described above in connection with the example(s) of FIGS. 1-5, or as described elsewhere herein. Thus, these and other modifications are all contemplated within the scope of the present disclosure.

In addition, although not expressly specified above, one or more steps of the respective methods 400, 500, or 600 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIGS. 4-6 that recite a determining operation or involve a decision do not necessarily require that both branches of the determining operation be practiced. In other words, one of the branches of the determining operation can be deemed as an optional step. Furthermore, operations, steps or blocks of the above-described method(s) can be combined, separated, and/or performed in a different order from that described above, without departing from the example embodiments of the present disclosure.

FIG. 7 depicts a high-level block diagram of a computing device or processing system specifically programmed to perform the functions described herein. For example, any one or more components or devices illustrated in FIGS. 1-3 or described in connection with the example(s) of FIGS. 4-6 may be implemented as the processing system 700. As depicted in FIG. 7, the processing system 700 comprises one or more hardware processor elements 702 (e.g., a microprocessor, a central processing unit (CPU) and the like), a memory 704, (e.g., random access memory (RAM), read only memory (ROM), a disk drive, an optical drive, a magnetic drive, and/or a Universal Serial Bus (USB) drive), a module 705 for assigning at least one protocol data unit session for at least one user equipment to a floating user plane function, for performing a data communication with a remote network via a floating user plane function for the at least one protocol data unit session for at least one user equipment, and/or for performing a data communication with a remote network via a floating user plane function for at least one protocol data unit session for a first user equipment, and various input/output devices 706, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 702 can also be configured or programmed to cause other devices to perform one or more operations as discussed above. In other words, the hardware processor 702 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above-disclosed method(s). In one example, instructions and data for the present module or process 705 for assigning at least one protocol data unit session for at least one user equipment to a floating user plane function, for performing a data communication with a remote network via a floating user plane function for the at least one protocol data unit session for at least one user equipment, and/or for performing a data communication with a remote network via a floating user plane function for at least one protocol data unit session for a first user equipment (e.g., a software program comprising computer-executable instructions) can be loaded into memory 704 and executed by hardware processor element 702 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above-described method(s) can be perceived as a programmed processor or a specialized processor. As such, the present module 705 for assigning at least one protocol data unit session for at least one user equipment to a floating user plane function, for performing a data communication with a remote network via a floating user plane function for the at least one protocol data unit session for at least one user equipment, and/or for performing a data communication with a remote network via a floating user plane function for at least one protocol data unit session for a first user equipment (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

In one example, the present disclosure discloses a device, computer-readable medium, and method for performing a data communication with a remote network via a floating user plane function for the at least one protocol data unit session for at least one user equipment. For instance, a processing system including at least one processor of a first user equipment may obtain an instruction to activate at least a portion of a floating user plane function, where the floating user plane function is hosted on at least one host mobile communication device, and where the at least one host mobile communication device comprises the first user equipment. The processing system may then obtain assignment of at least one protocol data unit session for at least one user equipment to the floating user plane function and may perform at least one of: transmitting data to or receiving data from a data network via the floating user plane function for the at least one protocol data unit session for the at least one user equipment.

In one example, the obtaining of the assignment may include obtaining at least one rule for processing data traffic of the at least one protocol data unit session for the at least one user equipment, where the transmitting of the data to or receiving of the data from the data network is in accordance with the at least one rule. In one example, the at least one rule may comprise at least one of: a packet detection rule, a forwarding action rule, a buffering action rule, a quality of service enforcement rule, or a usage reporting rule. In one example, the at least one user equipment may comprise the first user equipment. In another example, the at least one user equipment may comprise at least a second user equipment that does not host a portion of the floating user plane function. In one example, the processing system, in accordance with the floating user plane function, transmits data to and receives data from the at least the second user equipment via a cellular sidelink. In one example, the floating user plane function may be assigned to an area, and the method may further comprise transmitting a notification to at least one of a session management function or at least a second user equipment of the at least one host mobile communication device of the first user equipment leaving the area. In one example, the method may further comprise transferring at least one rule for processing data traffic of the at least one protocol data unit session for the at least one user equipment to the at least the second user equipment or to at least a third user equipment. In one example, the at least the portion of the floating user plane function may operate in a non-user-accessible portion of the first user equipment.

In another example, the present disclosure discloses a device, computer-readable medium, and method for performing a data communication with a remote network via a floating user plane function for at least one protocol data unit session for a first user equipment. For instance, a processing system including at least one processor of a first user equipment may obtain from a session management function of a cellular network, a notification indicating an assigning of at least one protocol data unit session for the first user equipment to a floating user plane function, where the floating user plane function is hosted on at least one host mobile communication device. The processing system may then perform a data communication with a data network via the floating user plane function for the at least one protocol data unit session, where the data communication via the floating user plane function is via a cellular sidelink between the first user equipment and the at least one host mobile communication device.

In one example, the notification may include at least one identifier of the at least one host mobile communication device, wherein the performing of the data communication utilizes the identifier. In one example, the method may further comprise transmitting, to the cellular network, at least one of: location information of the first user equipment or application usage information of the first user equipment, where the notification is further in response to the at least one of the location information or the application usage information.

What is claimed is:

1. A method comprising:
detecting, by a processing system including at least one processor deployed in a cellular network, at least one trigger condition for deploying a floating user plane function in an area;
deploying, by the processing system, the floating user plane function in the area in response to the detecting of the trigger condition, wherein the floating user plane function is hosted on at least one host mobile communication device that is in communication with the processing system; and
assigning, by the processing system, at least one protocol data unit session for at least a first user equipment to the floating user plane function.

2. The method of claim 1, further comprising:
obtaining an attach request from the first user equipment;
allocating a network-based user plane function to a first protocol data unit session for the first user equipment; and
activating the first protocol data unit session for the first user equipment.

3. The method of claim 2, wherein the at least one protocol data unit session that is assigned to the floating user plane function comprises:
a second protocol data unit session for the first user equipment.

4. The method of claim 2, wherein the at least one protocol data unit session that is assigned to the floating user plane function comprises:
the first protocol data unit session for the first user equipment.

5. The method of claim 4, wherein the assigning comprises:
transferring the first protocol data unit session for the first user equipment to the floating user plane function.

6. The method of claim 2, wherein the attach request comprises:
an initial attach request; or
a handover request.

7. The method of claim 1, wherein the assigning comprises:
transmitting a notification message to the first user equipment of the assigning of the at least one protocol data unit session for the at least the first user equipment to the floating user plane function.

8. The method of claim 1, wherein the assigning comprises:
transmitting a notification message to a radio access network equipment of the assigning of the at least one protocol data unit session for the at least the first user equipment to the floating user plane function.

9. The method of claim 1, wherein the processing system comprises at least one of:
an access management function;
a session management function; or
a network-based user plane function.

10. The method of claim 1, wherein the at least one host mobile communication device comprises the first user equipment.

11. The method of claim 1, wherein the floating user plane function passes data traffic of the at least one protocol data unit session between the at least the first user equipment and at least one data network.

12. The method of claim 1, wherein the first user equipment connects to the floating user plane function via a cellular sidelink.

13. The method of claim 1, wherein the floating user plane function implements at least one quality of service policy with respect to data traffic of the at least one protocol data unit session between the at least the first user equipment and at least one data network.

14. The method of claim 13, wherein the assigning further comprises:
transmitting the at least one quality of service policy to the floating user plane function.

15. The method of claim 1, wherein the at least one trigger condition comprises at least one of:
a load of a user plane function exceeding a first threshold; or
a predicted load of the user plane function exceeding a second threshold.

16. The method of claim 1, wherein the at least one trigger condition comprises a presence of a threshold number of user equipment of a designated class in the area.

17. The method of claim 1, wherein the at least one trigger condition comprises a utilization of an application type or application class via a user plane function exceeding a threshold.

18. The method of claim 1, wherein the at least one trigger condition is detected via at least one machine learning model.

19. A method comprising:
obtaining, by a processing system including at least one processor of a first user equipment, an instruction to activate at least a portion of a floating user plane function, wherein the floating user plane function is hosted on at least one host mobile communication device, wherein the at least one host mobile communication device comprises the first user equipment;
obtaining, by the processing system, an assignment of at least one protocol data unit session for at least one user equipment to the floating user plane function; and
performing, by the processing system, at least one of: transmitting data to or receiving data from a data network via the floating user plane function for the at least one protocol data unit session for the at least one user equipment.

20. A method comprising:
obtaining, by a processing system of a first user equipment from a session management function of a cellular network, a notification indicating an assigning of at least one protocol data unit session for the first user equipment to a floating user plane function, wherein the floating user plane function is hosted on at least one host mobile communication device; and
performing, by the processing system, a data communication with a data network via the floating user plane function for the at least one protocol data unit session, wherein the data communication via the floating user plane function is via a cellular sidelink between the first user equipment and the at least one host mobile communication device.
